(19) United States
(12) Patent Application Publication
(10) Pub. No.: US 2013/0073097 A1
(43) Pub. Date: Mar. 21, 2013

(54) AREA SOIL MOISTURE AND FERTILIZATION SENSOR

(71) Applicant: Nikola V. Vidovich, El Dorado Hills, CA (US)

(72) Inventor: Nikola V. Vidovich, El Dorado Hills, CA (US)

(73) Assignee: Dennis Vidovich, El Dorado Hills, CA (US)

(21) Appl. No.: 13/236,361

(22) Filed: Sep. 19, 2011

(51) Int. Cl. A01G 25/16

(52) U.S. Cl. 700/284

(57) ABSTRACT

The present invention relates to a method and a system for irrigation and fertilization control in a vast area, based on measuring the soil resistive electrical conductance values, during watering and fertilization cycles. A continuous electric field is created below the subsurface of the large soil area by a device that is spaced many feet apart in order to propagate an electric field through the soil. This alternating electric field averages soil conductance and therefore eliminates effects of non-uniformity in a monitored area. Furthermore, absolute conductance variations over long time periods offer the accurate point in time for soil fertilization.

### FIELD OF THE INVENTION

The present invention relates to irrigation and a fertilization control system. More particularly, the present invention provides a method and a system for delivering adequate amount of water and fertilizer to a vast area.

### BACKGROUND OF THE INVENTION

World's limited water resource is one of the primary reasons for restricted agriculture production in many areas. The limited resource availability necessitates use of controlled irrigation in soil fields. Efficient use of water and fertilizer are important components of sustainable green house production and improved crop productivity.

Irrigation or watering systems are well known in the art. Conventional growing practices often utilize sprinkler and flood-type irrigation techniques to irrigate the agricultural fields. In addition, mass spraying of chemicals is used for fumigating and fertilizing the agricultural fields.

Sprinkler systems are the devices with perforations, through which water issues from a hose to sprinkle a lawn. These systems are generally controlled by a system timer set to run watering cycles for a fixed period of time on a list of days of the week and/or the month. Flood Irrigation is another technique in which the water is pumped or brought to the fields and is allowed to flow along the ground among the crops. This method is simple and cheap and is widely used by societies in less developed parts of the world.

However, sprinkler and flood irrigation along with mass spraying, besides being wasteful of water and chemical resources, often damage the surface soils and both ground water and surface water sources. Irrigating floodwater applied to fields promotes erosion and promotes run-off of fertilizers and pesticides into water sources. In arid environments flood irrigation often leads to soil mineralization associated with the build-up of surface salts. Flood irrigation also creates large swings over time in the amount of moisture in the soil, which stresses the plants.

Furthermore, in traditional flood irrigation a significant percentage of water applied to the field is lost either through evaporation to the air or downward migration below the effective root zone of the plants. The downward migration of water also has the negative consequence of carrying fertilizers, pesticides and insecticides into the groundwater. This technique wastes water resources, as does the more advanced sprinkler techniques, although to a lesser extent.

Nowadays, irrigation methods use single moisture sensor or multitude of moisture sensors, to provide feedback from the soil. They contain encased electronic components that are inserted into the soil and cover several square inches of the soil area. They are often referred to as point sensors. Multitude of moisture sensors provides spot measurement and there is no continuous electric field across the soil. They have had limited success, because they tend to measure the absolute soil moisture level. The main problem with such device is that soil conditions can significantly modify the readings. These changes in soil conditions may be caused by, for example, salts from fertilizers, soil compactness changes with time, leakage conductance from faulty wire splicing, and electrochemical deposition on moisture probes themselves. Any of these changes in soil conditions often requires a manual readjustment to the irrigation system controller for optimal performance.

In addition, generic tables and charts are commonly used to determine the amounts of water and fertilizer that should be used for irrigation. These tables and charts serve as generic tools and were generated as “one size fit all” solution. They do not provide the grower with any direct analysis presentation that fit individual needs of his own crop in terms of water and fertilizer application at a given point in time.

Thus, traditional irrigation and fertilization methods are very wasteful of resources and are not focused on plant production and have a harsh impact on the environment.

Therefore, there is a long felt need to provide a method for irrigation and fertilization control that is based on the immediate actual needs of the plants at any time, place and weather, rather than generating a one time decision and covers a large surface area of the soil.

In light of foregoing discussion, a method and a system is presented for simultaneous operation of irrigation and fertilization in a vast area, based upon the immediate actual needs of the plants at any time. The method and system provides controlled irrigation and fertilization by generating a continuous electric field across the vast area.

### BRIEF SUMMARY OF THE INVENTION

In view of the foregoing limitations associated with the use of traditional technology, a method and a system is presented for simultaneous operation of irrigation and fertilization in a vast area.

Accordingly an object of the present invention is to provide a system and a method for simultaneously operating irrigation and fertilization in a vast area.

Another object of present invention is to provide a method and a system for controlled irrigation and fertilization that eliminates the need for adjustments as memorized soil conductance values are used as referenced values for consequent irrigation and fertilization cycles.

Another object of present invention is to provide soil conductivity measurements for controlled irrigation and fertilization that tend to remain unaffected by the type of soil, its condition, soil non-uniformity and the spacing of a device that can create an electric field in the soil.

Accordingly in an aspect of the present invention, a method for simultaneously operating irrigation and fertilization system in a vast area is provided. The method comprises of placing a device in the vast area to be monitored; creating an electric field below the subsurface of the vast soil area; measuring an instantaneous soil conductance value (Sc) using the device; storing the maximum soil conductance value (Scmax) when the soil is water saturated; storing the maximum fertilized soil conductance value (Scfmax) when the soil is fertilizer and water saturated; turning on an electric valve for starting water flow, when the instantaneous soil conductance value (Sc) reaches a fraction less than p times Scmax; turning off an electric valve for stopping water flow, when the instantaneous soil conductance value (Sc) reaches a fraction greater than or equal to p times Scmax; continuously comparing maximum soil conductance value (Scmax) with maximum fertilized soil conductance value (Scfmax); and turning on an electric valve for starting fertilizer flow, when the instantaneous soil conductance value after fertilization (Scf), reaches a fraction less than q times Scfmax.

In another aspect of present invention, a system for simultaneous operation of irrigation and fertilization in the vast area is provided. The system includes a device to sense soil moisture content; a unit to measure soil conductance; a non-volatile memory that stores a maximum soil conductance value (Scmax) when the soil is water saturated, and a maximum fertilized soil conductance value (Scfmax) after fertilization and irrigation; a microcontroller programmed to compare the maximum soil conductance value (Scmax) with maximum fertilized soil conductance value (Scfmax) and to turn on an electric valve for starting fertilizer flow, when instantaneous soil conductance value after fertilization (Scf) reaches a fraction less than q times of the maximum fertilized soil conductance value (Scfmax); a voltage comparator to turn on an electric valve for starting water flow when the instantaneous soil conductance value (Sc) reaches a fraction less than p times of the maximum soil conductance value (Scmax); and a voltage comparator to turn off an electric valve for stopping water flow when the instantaneous soil conductance value (Sc) reaches a fraction greater than or equal to p times of the maximum soil conductance value (Scmax).

### BRIEF DESCRIPTION OF THE DRAWINGS

The preferred embodiments of the invention will hereinafter be described in conjunction with the Figures provided herein to further illustrate various non-limiting embodiments of the invention, wherein like designations denote like elements, and in which:

FIG. 1 is a block diagram illustrating an exemplary method for simultaneously operating irrigation and fertilization system in the vast area, in accordance with an embodiment of the present invention

FIG. 2 is a graph illustrating the effect of irrigation on the soil conductance value, in accordance with an embodiment of the present invention.

FIG. 3 is a graph illustrating the effect of fertilization on the soil conductance value after fertilization, in accordance with an embodiment of the present invention.

FIG. 4 illustrates a schematic representation of a system for simultaneous operation of irrigation and fertilization in the vast area, in accordance with an embodiment of the present invention

FIG. 5 illustrates an exemplary graphical representation of soil resistance variation relative to the metal plates distance, in accordance with an embodiment of the present invention.

### DETAILED DESCRIPTION OF INVENTION

In the following detailed description of embodiments of the invention, numerous specific details are set forth in order to provide a thorough understanding of the embodiment of the invention. However, it will be obvious to a person skilled in art that the embodiments of invention may be practiced with or without these specific details. In other instances well known methods, procedures and components have not been described in details so as not to unnecessarily obscure aspects of the embodiments of the invention.

Furthermore, it will be clear that the invention is not limited to these embodiments only. Numerous modifications, changes, variations, substitutions and equivalents will be apparent to those skilled in the art, without parting from the spirit and scope of the invention.

The present invention relates to a method and a system for simultaneously operating irrigation and fertilization in a vast area that includes more than thousand square feet. An electric field is created by inserting a device in the vast area to be monitored.

A device includes being, and is not limited to, a pair of metal plates, a pair of conductive plates, a pair of carbon electrodes, a pair of metal sheets, metalized plastic unit, plastic pipe with a metal cone and plastic pipe with multitude of small metal rings. Plastic pipe with a metal cone provides easier soil insertion and a plastic pipe with multitude of small metal rings provides information regarding soil depth profile of water and fertilizer down percolation. The device is made into a shape selected from the group consisting of a cylinder, a rectangle, a square, a trapezium, a triangle, a curve polygon, a hybrid curve, a cuboid, and an ellipse. Furthermore, the device provides electrical connections to the soil and contains no electrical component.

Soil non-uniformity such as low-watered spots, tree trunks, bare soil, point discrepancies etc do not effect operation, as electric field lines will bend around and under such obstacles. Furthermore, the soil conductivity measurements tend to be unaffected by the type of soil, its condition, or the spacing of the device that can create an electric field in the soil.

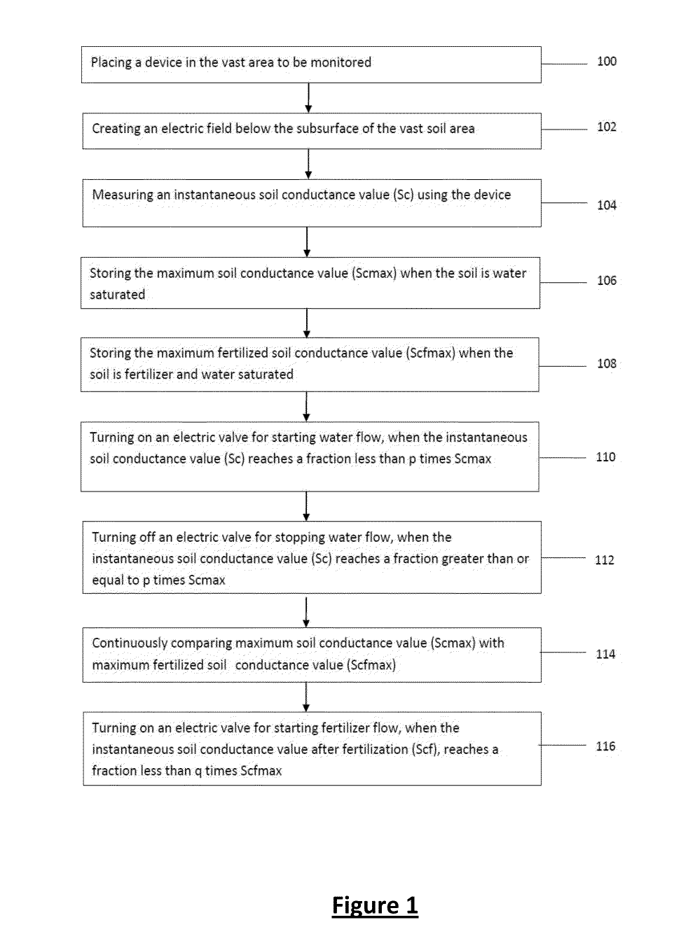

FIG. 1 is a block diagram illustrating an exemplary method for simultaneously operating irrigation and fertilization system in the vast area, in accordance with an embodiment of the present invention. In an embodiment of the present invention, the method includes the following steps: Step 100: placing the device 404 in the vast area to be monitored; Step 102: creating an electric field below the subsurface of the vast soil area; Step 104: measuring an instantaneous soil conductance value (Sc) 202 using the device 404; Step 106: storing the maximum soil conductance value (Scmax) 206 when the soil is water saturated; Step 108: storing the maximum fertilized soil conductance value (Scfmax) 304 when the soil is fertilizer and water saturated; Step 110: turning on an electric valve for starting water flow, when the instantaneous soil conductance value (Sc) 202 reaches a fraction less than p times Scmax 206; Step 112: turning off an electric valve for stopping water flow, when the instantaneous soil conductance (Sc) value 202 reaches a fraction greater than or equal to p times Scmax 206; Step 114: continuously comparing maximum soil conductance value (Scmax) 206 with maximum fertilized soil conductance value (Scfmax) 304; Step 116: turning on an electric valve for starting fertilizer flow, when the instantaneous soil conductance value after fertilization (Scf) 302, reaches a fraction less than q times Scfmax 306.

In an embodiment of the present invention, the device 404 is placed at a distance ranging from 3 feet to more than 100 feet in the vast area where irrigation and fertilization is to be controlled. The device 404 provides electrical connections to the soil by generating an electric field. The projected electric field spreads uniformly into the subsurface. The electric field is created by sinusoidal alternating current voltage that eliminates the influence of soil electrolytic characteristics on measurements. The soil conductance is determined by measuring the electric conductance created by the device 404.

In an embodiment of the present invention, two metal probes 404a and 404b within the device 404 are hammered in to soil at some large distance (d) apart, an inch or more under top soil surface. These probes form electrical contacts to the soil. A steady electrical alternating voltage creates an electric alternating voltage of several volts and low frequency applied between probes 404a and 404b. The width of the electric field is approximately 5 times the distance between the probe (5d). The monitored area covered by the electrical field is five times the square of distance between the probe.

In a uniform turf area, the coverage for a probe placed 30′ apart, will provide information about the soil conditions in 4,500 sq.ft.

In another embodiment of the present invention, the vast area to be monitored for sensing is more than thousand square feet. The area sensing provides accurate information for fertilization and averages soil electrical conductance, and eliminates non uniformity influence.

In another embodiment of the present invention, the maximum soil conductance value (Scmax) 206 is the conductance value, when the soil is fully saturated with water. The instantaneous soil conductance value (Sc) 202 and the maximum soil conductance value (Scmax) 206 keeps on changing over time. The microcontroller 408 compares the instantaneous soil conductance value (Sc) 202 with the maximum soil conductance value (Scmax) 206 and sends the command to the voltage comparator 412 to turn on or turn off an electric value for controlling water flow, depending upon the measured values of instantaneous soil conductance (Sc) 202 and maximum soil conductance (Scmax) 206, obtained at different intervals of time. The electric valve is turned on, when the instantaneous soil conductance value (Sc) 202 reaches a fraction less than p times of the maximum soil conductance value (Scmax) 206 and the electric valve is turned off, when the instantaneous soil conductance value (Sc) 202 reaches a fraction greater than or equal to p times of the maximum soil conductance value, Scmax 206. The value of p is less than 1 and ranges from 0.3 to 0.9

In yet another embodiment of the present invention, the maximum fertilized soil conductance value (Scfmax) 304 is the maximum soil conductance value that is obtained after adding the fertilizer to the soil in required amount. During the course of time the amount of fertilizer in the soil starts depleting due to the consumption of nutrients by the plant. The depletion in the amount of fertilizer results in the decrease in the maximum soil conductance value, Scmax 206 over a period of time and the slope of Scmax 206 curve starts decreasing. The instantaneous soil conductance value after fertilization (Scf) 302 is compared with q times of the maximum fertilized soil conductance value (gScfmax) 306 and an electric valve for starting fertilizer flow is turned on when the instantaneous soil conductance value after fertilization (Scf) 302, reaches a fraction less than q times Scfmax 306.

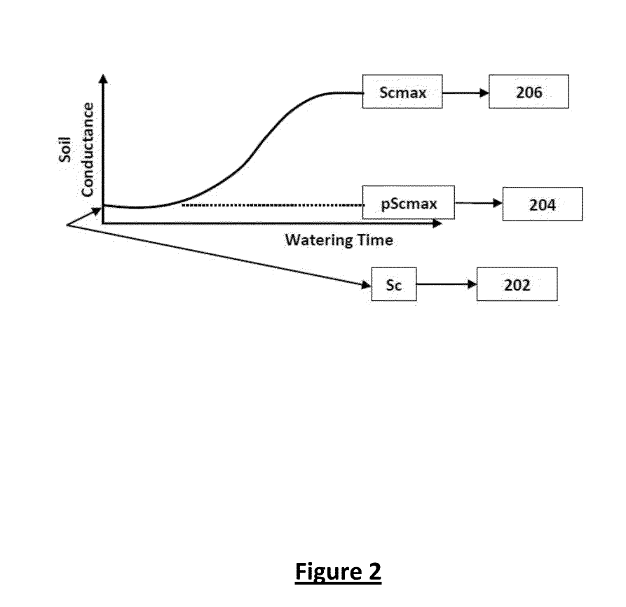

FIG. 2 is a graph illustrating the effect of irrigation on the soil conductance value, in accordance with an embodiment of the present invention.

The sigmoid curve indicates that during watering the instantaneous soil conductance, Sc 202 changes with time and is measured every several minutes. The water absorption by the soil is very slow at the start of the irrigation cycle and then speeds up with the irrigation cycle. The point at which the soil absorption speeds up is called as pScmax 204. After certain time the soil stops absorbing water, and the soil conductance, Sc 202 curve levels off at the top. The point at which the soil conductance levels off at the top is called the maximum soil conductance value, Scmax 206.

In an embodiment of the present invention, the values of instantaneous soil conductance, Sc 202 and pScmax 204 are measured at different intervals of time and the decision for turning on or turning off an electric valve for controlling water flow, depends upon the measured values of soil conductance, Sc 202 and pScmax 204, at different intervals of time. The electric valve is turned on, when the instantaneous soil conductance value (Sc) 202 reaches a fraction less than p times of the maximum soil conductance value (Scmax) 206 and the electric valve is turned off, when the instantaneous soil conductance (Sc) 202 reaches a fraction greater than or equal to p times of the maximum soil conductance value (Scmax) 206. The value of p is less than one and the value ranges from 0.3 to 0.9.

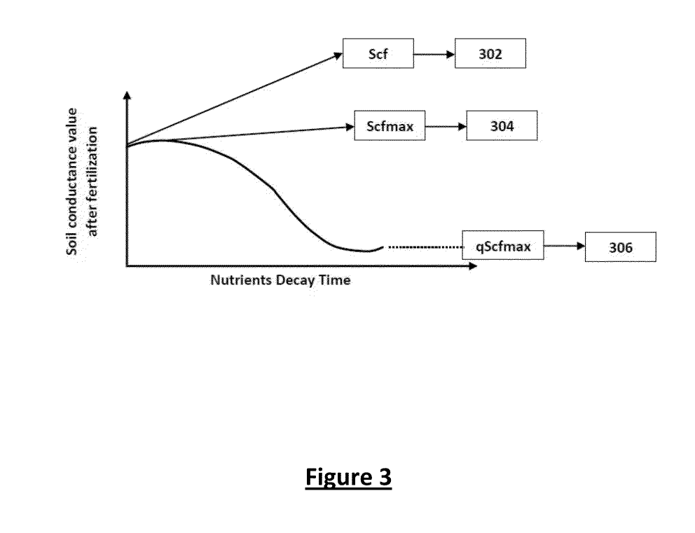

FIG. 3 is a graph illustrating the effect of fertilization on the soil conductance value after fertilization, in accordance with an embodiment of the present invention.

The inverted S shaped curve illustrates the depletion of nutrients out of the soil over long time periods. The curve depicts this process over several weeks in a horizontal axis. The electrical conductivity of the soil increases multiple times right after fertilization.

The fertilizer consumption is very slow at the beginning of the fertilization cycle and normally it takes several months for nutrient depletion. The maximum fertilized soil conductance value, Scfmax 304 is obtained when the soil is water saturated and adequate amount of fertilizer has been added to the soil. The depletion of nutrients continues until a stagnant point is reached at which it becomes necessary to fertilize the soil again. This point is called as qScfmax 306.

In an embodiment of the present invention, the instantaneous soil conductance value after fertilization, Scf 302 and qScfmax 306 are measured at different intervals of time and the decision for turning on an electric valve for controlling fertilizer flow, depends upon the measured values of instantaneous soil conductance value after fertilization, Scf 302 and qScfmax 304 obtained at different intervals of time. The electric valve for starting fertilizer flow is turned on, when instantaneous soil conductance value after fertilization (Scf) 302 reaches a fraction less than q times Scfmax 306. The value of q is less than 1 and ranges from 0.3 to 0.9.

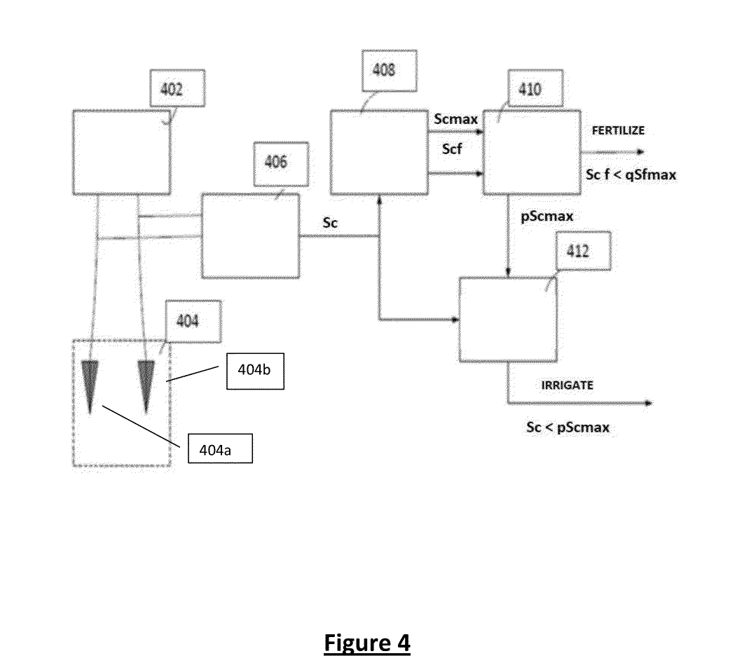

FIG. 4 illustrates a schematic representation of a system for simultaneous operation of irrigation and fertilization in the vast area, in accordance with an embodiment of the present invention. The system comprises of the device 404 to sense the soil moisture content, a voltage source 402 for supplying voltage to the device 404, a soil conductance measuring unit 406, a microcontroller 408 programmed to compare the maximum soil conductance value (Scmax) 206 with the maximum fertilized soil conductance value (Scfmax) 304, a non volatile memory 410 for storing the soil conductance values and a voltage comparator 412.

In an embodiment of the present invention, the device 404 is hammered in the soil at some distance apart, under soil top surface. The device 404 is placed in the soil for which the conductivity is to be measured. The voltage source 402 supplies the steady AC voltage of several volts at low frequency to the device 404. A steady electrical alternating voltage of several volts and low frequency is applied to the device 404. The voltage creates an electric field which spreads left and right of the line of sight. The soil conductance measuring unit 406 is connected to the device 404 and the voltage source 402, to measure the soil conductance, Sc 202. During the irrigation cycle, the value of soil conductance, Sc 202 changes with time and is measured by the soil conductance measuring unit 406 at regular intervals. At the initial stage, the water absorption is very slow and then it speeds up, which result in change of soil conductance value, Sc 202. After a considerable time, the soil stops absorbing water and the soil conductance reaches the maximum value, Scmax 206. The values of maximum soil conductance, Scmax 206 keeps on changing over time and are continuously updated in the non volatile memory 410.

In another embodiment of the present invention, the microcontroller 408 calculates the rate of change of soil conductance 202 during watering cycle and on reaching the maximum soil conductance value Scmax 206, compares it with the previous value stored in the non volatile memory 410. When the instantaneous soil conductance value (Sc) 202 reaches a fraction less than p times of the maximum soil conductance value (Scmax) 206, the microcontroller 408 sends the feed back to the voltage comparator 412 to turn on an electric valve for starting water flow and when the instantaneous soil conductance value (Sc) 202 reaches a fraction greater than or equal to p times of the maximum soil conductance value (Scmax) 206, the microcontroller 408 sends the feed back to the voltage comparator 412 to turn off an electric valve for stopping water flow. The value of p is less than one and ranges from 0.3 to 0.9.

In another embodiment of the present invention, plants deplete nutrients out of the soil over long time periods and it takes several months for nutrient depletion. During the fertilization cycle, the soil conductance, Sc 202 increases multiple times right after fertilization. The maximum fertilized soil conductance value, Scfmax 304 that is obtained after fertilization and irrigation is stored in the non volatile memory 410. Over many weeks after fertilization, the microcontroller 408 compares the maximum soil conductance value (Scmax) 206 with the maximum fertilized soil conductance value (Scfmax) 304 at regular intervals of certain number of irrigation cycles. The microcontroller 408 turns on an electric valve for starting fertilizer flow, when instantaneous soil conductance value after fertilization (Scf) 302 reaches a fraction less than q times Scfmax 306. The value of q is less than one and ranges from 0.3 to 0.9. The non volatile memory 410 may be a part of the microcontroller 408.

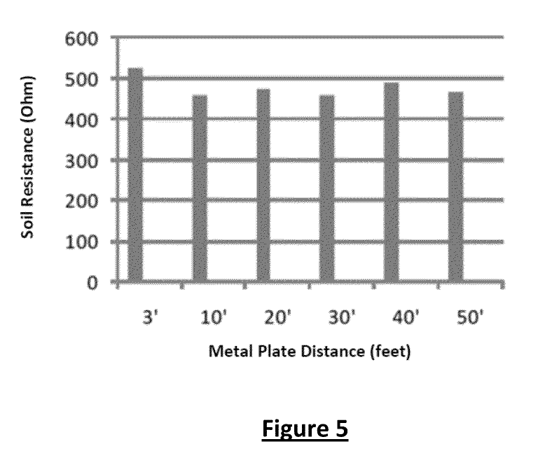

FIG. 5 illustrates a graphical representation of soil resistance variation relative to the metal plate distance, in accordance with an embodiment of the present invention.

In an exemplary embodiment of the present invention, the experiment for calculating the relation between the soil resistance and the metal plate distance was conducted in a large park, having an area of approximately 70,000 sq. ft. The resistance of the soil was measured by placing the metal plates at different distances in the field. The experimental value was calculated when the two metal plates are placed at a distance, ranging from 3 feet to 50 feet.

In another embodiment of the present invention, it was found that the measured soil resistance values are approximately 470 ohm+/−3%, at metal plate distances, that are approximately within the range of 10 to 50 feet. More specifically, the soil resistance was calculated to be around 520 ohm, 470 ohm, 480 ohm, 470 ohm, 495 ohm and 475 ohm, when the two metal plates are placed at a distance of 3 feet, 10 feet, 20 feet, 30 feet, 40 feet and 50 feet from each other respectively. Therefore, this experiment illustrates that the distances between the metal plates have no significant effect on the values of soil resistance.

We claim:

1. A method for simultaneously operating irrigation and fertilization control in an agricultural area comprising:
creating an electric field below the soil surface of said agriculture area to measure soil conductance value of said agricultural area;
constantly measuring the soil conductance change during irrigation;
stopping the irrigation when change in soil conductance is small and memorizing the instantaneous conductance value as a first reference value;
starting the irrigation when the soil conductance falls below a predetermined fraction p of the said first reference value;
measuring the soil conductance value when the soil is water and fertilizer saturated and storing the said conductance value as a second reference value;
comparing the said first reference value with the said second reference value;
starting the fertilization when the first reference value falls below a predetermined fraction q of the said second reference value.

2. The method of claim 1 wherein the said agricultural area is more than thousand square feet.

3. The method of claim 1 wherein the said electric field is created by sinusoidal electric current and spread uniformly below the soil surface.

4. The method of claim 1 wherein the said first reference value is measured and memorized after each irrigation cycle.

5. The method of claim 1 wherein the first reference value is compared with the second reference value after a predetermined value of irrigation cycle, the said predetermined value of irrigation cycle is more than 1.

6. A method for simultaneously operating irrigation and fertilization control in an agricultural area comprising:
creating an electric field below the soil surface of the said agriculture area;
measuring an instantaneous conductance value of the soil;
storing an irrigated conductance value and a fertilized conductance value as a reference value; the said irrigated conductance value is the conductance when the soil is water saturated and the said fertilized conductance value is the conductance when the soil is fertilizer and water saturated;
comparing the instantaneous conductance value with the said irrigated conductance value;
regulating the irrigation supply when the said instantaneous conductance value falls below a predetermined fraction p of said irrigated conductance value;
comparing the irrigated conductance value with said fertilized conductance value;
regulating the fertilizer flow when the irrigated conductance value falls below a predetermined fraction q of said fertilized conductance value.

7. The method of claim 6 wherein the said agricultural area is more than thousand square feet.

8. The method of claim 6 wherein the soil conductance is determined by measuring the electric conductance created by the electric field, the said electric field is created by sinusoidal wave that spread continuously below the soil surface.

9. The method of claim 6 wherein the said instantaneous conductance value is compared with said irrigated fertilized value constantly.

10. The method of claim 6 wherein the said irrigated conductance value is measured at regular interval and is continuously updated as the reference value.

11. The method of claim 6 wherein the said irrigated conductance value is compared with the fertilized conductance value after a predetermined value of irrigation cycle, where in the said predetermined value of irrigation cycle is more than 1.

12. A system for operating simultaneously irrigation control and fertilization control in an agricultural area comprising:
a device to create an electric field below the soil surface of said agricultural area;
a device to measure an instantaneous conductance value of soil of said area;
a non-volatile memory to store an irrigated conductance value, the said irrigated conductance value being the soil conductance when the soil is water saturated; and a fertilized conductance value, the said fertilized conductance value being the conductance when the soil is water and fertilizer saturated;
a microcontroller that compares the instantaneous conductance value with the said irrigated conductance value, the said comparing means regulates the irrigation supply when the said instantaneous conductance value falls below a predetermined fraction p of said irrigated conductance value;
the microcontroller that compares the irrigated conductance value with said fertilized conductance value, the said microcontroller regulates the fertilizer flow when the irrigated conductance value falls below a predetermined fraction q of said fertilized conductance value.

13. The system of claim 12 wherein the said agriculture area is more than thousand square feet.

14. The system of claim 12 wherein the said means to create an electric field below the soil surface comprises of a pair of electrically connected metal plates, metal sheets, a metalized plastic unit, a plastic pipe with a metal cone or a plastic pipe with multitude of small metal rings, wherein the component of said pair are spaced at a distance of 10 to 200 feet.

15. The system of claim 12 wherein the said means for creating the electric field uses sinusoidal alternating current voltage to generate uniformly spread electric field.

16. The system of claim 12 wherein the said instantaneous soil conductance values is measured constantly.

17. The system of claim 12 wherein the said irrigated conductance value is measured at regular intervals and is continuously updated in the said non volatile memory.

18. The system of claim 12 wherein the said microcontroller compares the irrigated conductance value with the fertilized conductance value after a predetermined value of irrigation cycle, where in the said predetermined value of irrigation cycle is more than 1.

19. The system of claim 1 wherein the said predetermined fraction p is less than 1.

20. The system of claim 1 wherein the said predetermined fraction q is less than 1.
